(19) United States
(12) Patent Application Publication
(10) Pub. No.: US 2003/0133165 A1
(43) Pub. Date: Jul. 17, 2003

(54) Screen white board

(76) Inventor: Bae Ju Kim, Kyungsangbuk-do (KR)

Correspondence Address: BURNS DOANE SWECKER & MATHIS L L P, POST OFFICE BOX 1404, ALEXANDRIA, VA, 22313-1404, US

(21) Appl. No.: 10/065,321

(22) Filed: Oct. 3, 2002

(30) Foreign Application Priority Data
Oct. 6, 2001 (KR) 2001-0030813

(51) Int. Cl. H04N 1/21; H04N 1/23

(52) U.S. Cl. 358/296

(57) ABSTRACT

The present invention relates to a screen white board that can be used in anyplace and anytime during a seminar or a conference with no use of additional screen device when a board, a projector device, an O.H.P device, etc. is used. The screen white board has a screen and a white board integrated. Thus, the board is used for a common conference and the screen is used if an image is required using the projector or the O.H.P device. Further, the height of the screen is controlled so that the size of a screen can be adjusted. When the screen is not used, the screen is fixed to the upper side of the board. Due to this, the screen can be easily placed at a narrow place. In addition, the board is a magnet type to which printed matter and a chart can be attached. The support plate is made of a strong material. A roller is attached to the bottom of the support plate so that it can be easily moved and installed.

### BACKGROUND OF INVENTION

1. Field of the Invention

The invention relates generally to a screen white board that can be used at any place for a meeting, conference, seminar and/or education, capable of minimizing an inconvenience that several tools must be moved and then installed at a place where a conference and education is held.

2. Description of the Prior Art

Generally, in case that a meeting, conference, seminar, video-conference and/or education are to be held at a school, a company, or the like, a specific place must be prepared. Along with it, it is required that lots of meeting tools be moved to the place where the meeting is held. It is thus impossible to hold a conference, meeting, etc. at a narrow space if lots of meeting tools are required. In this connection, there is a problem that the meeting, conference, etc. is limited to a place.

### SUMMARY OF THE INVENTION

The present invention is contrived to solve the above problems and an object of the present invention is to provide a screen white board in which the screen and board are integrally designed by which a conference, a video conference, etc. can be held without limitation to a place when an education, seminar, etc. is held along with a conference and a video conference.

In order to accomplish the above object, a screen white board according to the present invention, is characterized in that it comprises a screen case in which a screen is automatically tied and untied, screen device poles having an adjusting groove for determining the height of the screen, and an adjusting pole, a support having an adjusting pole for raising and lowering the screen device poles, an upper support pole weld to both ends of the support and coupled to bolt holes of the screen device poles and both ends of the screen case, wherein the upper support pole is connected to an adjusting cam and an adjusting tube for adjusting the height by means of a wire, device poles on which a board shelf is mounted, a cam fixed to an upper side of the device pole by means of a bolt and having a procedure clip for preventing rotation of the board, a lower support pole weld to both ends of the device pole and coupled to the central portion of a fixing pin, wherein a table is attached to the bottom of the lower support pole, an oval support plate on which a moving roller for facilitating movement of the support plate is mounted at its front side and a moving roller for preventing deviation of the support plate is mounted at its rear side, a groove coupled to the bolt holes at the bottom of the device poles at the lower central portion of the support plate, by means of a bolt, and a board fixing pole coupled to the board shelf and mounted on the central portion of both sides of the white board, the board fixing pole allows the screen device poles to be coupled to an upper internal side of the device poles.

### BRIEF DESCRIPTION OF DRAWINGS

The aforementioned aspects and other features of the present invention will be explained in the following description, taken in conjunction with the accompanying drawings, wherein:

FIG. 1 is a front view of a screen white board according to the present invention;

FIG. 2 is a rear view of the screen white board according to the present invention; and

FIG. 3 is a dismantled perspective view of the screen white board according to the present invention.

### DETAILED DESCRIPTION

A screen white board of the present invention will be described in detail by way of a preferred embodiment with reference to accompanying drawings.

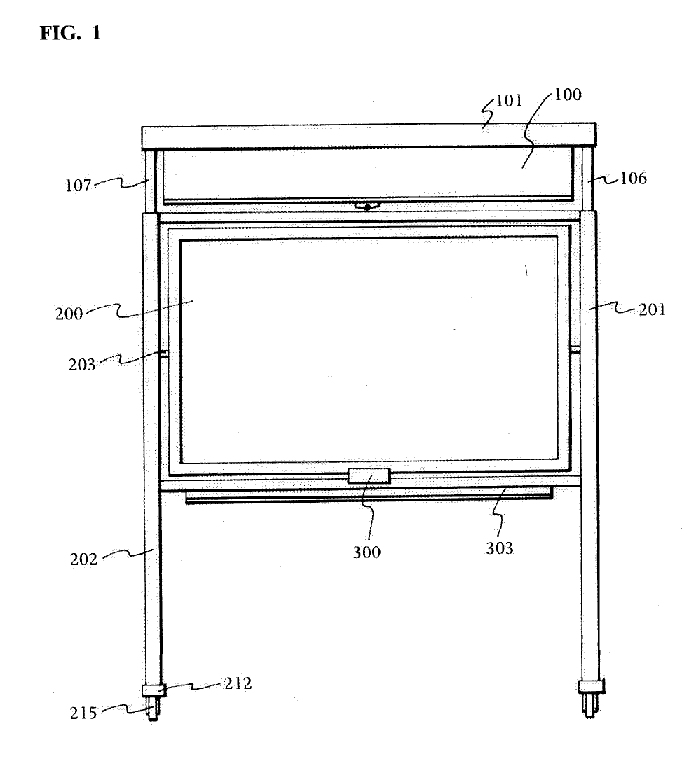

FIG. 1 is a front view of a screen white board according to the present invention,

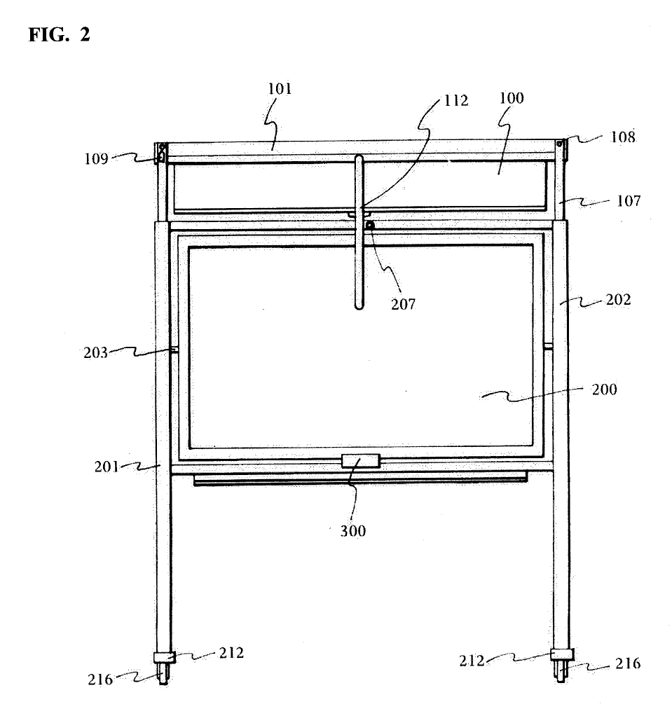

FIG. 2 is a rear view of the screen white board according to the present invention, and

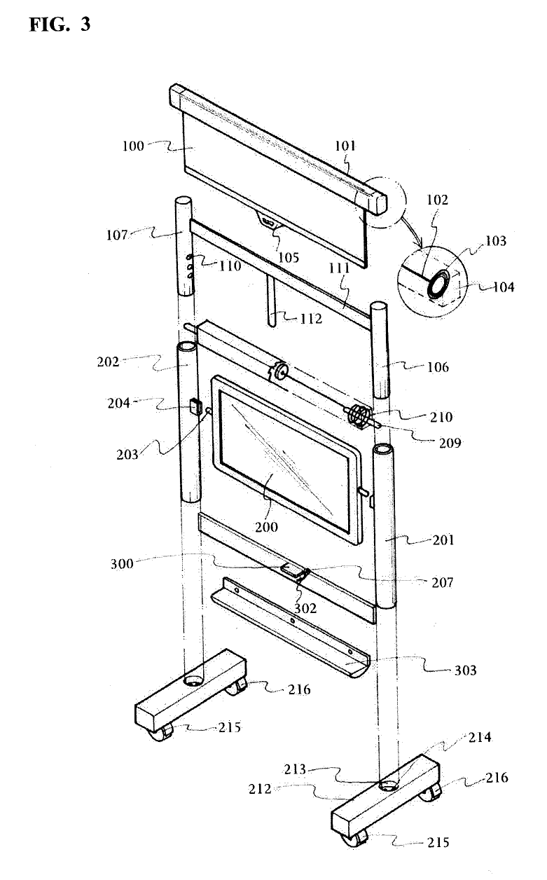

FIG. 3 is a dismantled perspective view of the screen white board according to the present invention.

The screen white board according to the present invention has a screen 100 and a white board integrated 200, which allows a user to use the screen white board at a narrow space. The screen white board includes a moving roller 215 at the front side of a support plate 212 and a moving roller 216 at the rear side of the support plate 212, for the purpose of easy installation. At this time, the moving roller 215 serves as a brake.

Further, the support plate 212 has an oval shape. The support plate 212 has a groove 213 at its upper central portion, through which a board device pole 201 passes. Therefore, the bottom of the support plate 212 is coupled to a groove 213 and is then fixed to bolt holes 214, 205 by bolts.

In order to prevent distortion and shaking of device poles 201, 202, an adjusting cam 210 in which an upper support pole 206 and a lower support pole 211 are installed and a fixing pin 209 is fixed within the upper support pole 206 by means of a spring is installed at both sides. The adjusting cam 210 is coupled to an adjusting tube 207 installed at the central portion of a wire 208.

Both sides of the upper support pole 206 and the device poles 201, 202 are fixed by a bolt. If the adjusting tube 207 is rotated, a fixing pin 209 is separate from the upper support pole 206 and the device poles 201, 202. A cam 302 is fixed to a fixing clip 300 in the lower support pole 211, so that board is not rotated.

In addition, the fixing pin 301 is coupled so that it can be decoupled by push when the board is rotated. Both ends of the lower support pole 211 to which a table 303, and the device poles 201, 202 are weld, in order to prevent distortion.

A shelf 204 is installed at an internal side of the device poles 201, 202. The white board is mounted to the shelf 204. Screen device poles 106, 107 are mounted into the upper side of the shelf 204. The white board 200 has magnets at both sides, to which a chart or printed matter can be attached.

Meanwhile, a board-fixing pole 203 is installed at the central portion of both sides of the white board 200. The board-fixing pole 203 is coupled to the shelf 204 and is rotated along with it.

An adjusting groove 110 is installed at an internal side of the screen device poles 106, 107. An adjusting pole 112 for adjusting the height is installed at an upper rear side of the adjusting screen poles 106, 107. The adjusting pole 112 is installed at the central portion of the support 111 in which an adjusting pole latch 109 is installed. With this construction, the screen device pole can be raised and lowered by the adjusting pole 112.

In addition, in order to prevent distortion when the screen device poles 106, 107 are operated, the screen device poles 106, 107 and both ends of the support 112 are weld. A windup spring 103 and a cam 104 are installed in the screen case 101 so that the wound pole 102 and the screen 100 are automatically tied and untied.

Meanwhile, the bolthole 108 at both ends of the case 101 and the upper aide of the screen device poles 106, 107 are fixed by a bolt. The screen device poles 106, 107 are coupled to the upper side of the device poles 201, 202.

As mentioned above, according to the present invention, the screen and the white board are integrally formed. With this structure, the screen white board can be easily installed and moved. Therefore, the present invention has advantages that an image conference, education, seminar, etc. can be made at anywhere and anytime without limitation of a place or time.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

1. A screen white board, comprising:
a screen case 101 in which a screen 100 is automatically tied and untied; screen device poles 106, 107 having an adjusting groove 110 for determining the height of the screen 100, and an adjusting pole 109;
a support 111 having an adjusting pole 112 for raising and lowering the screen device poles 106, 107;
an upper support pole 206 weld to both ends of the support 111 and coupled to bolt holes 108 of the screen device poles 106, 107 and both ends of the screen case 101, wherein the upper support pole 206 is connected to an adjusting cam 210 and an adjusting tube 207 for adjusting the height by means of a wire 208;
device poles 201, 202 on which a board shelf 204 is mounted; a cam 302 fixed to an upper side of the device pole by means of a bolt and having a procedure clip 300 for preventing rotation of the board;
a lower support pole 211 weld to both ends of the device pole and coupled to the central portion of a fixing pin 301, wherein a table 303 is attached to the bottom of the lower support pole 211;
an oval support plate 212 on which a moving roller 216 for facilitating movement of the support plate is mounted at its front side and a moving roller 215 for preventing deviation of the support plate is mounted at its rear side;
a groove 213 coupled to the bolt holes 205, 214 at the bottom of the device poles 201, 202 at the lower central portion of the support plate, by means of a bolt; and
a board-fixing pole 203 coupled to the board shelf and mounted on the central portion of both sides of the white board 200, the board-fixing pole 203 allows the screen device poles 106, 107 to be coupled to an upper internal side of the device poles 201, 202.
